(19) United States
(12) Patent Application Publication
(10) Pub. No.: US 2010/0182572 A1
(43) Pub. Date: Jul. 22, 2010

(54) POLARIZER ASSEMBLY AND A REFLECTIVE MODULATION-IMAGER PROJECTION SYSTEM

(76) Inventor: HERB HE HUANG, Shanghai (CN)

Correspondence Address: J C PATENTS, 4 VENTURE, SUITE 250, IRVINE, CA, 92618, US

(21) Appl. No.: 12/689,839

(22) Filed: Jan. 19, 2010

Related U.S. Application Data
(60) Provisional application No. 61/145,698, filed on Jan. 19, 2009.

(51) Int. Cl. G02B 27/28; G03B 21/14

(52) U.S. Cl. 353/20; 359/495

(57) ABSTRACT

The present application relates to a polarizer assembly and a reflective modulation-imager projection system. The polarizer assembly comprises a light source, a polarization beam splitter assembly, a first reflective quarter wave composite plate and a second reflective quarter wave composite plate. The light source is used for inducing a first polarized light and a second polarized light in a first direction. The polarization beam splitter assembly comprises a first polarization beam splitting film and a second polarization beam splitting film. The first polarization beam splitting film is used for reflecting the first polarized light as a first polarization reflected light in a second direction while transmitting the second polarized light. The second polarization beam splitting film is used for transmitting the second polarized light. The first reflective quarter wave composite plate is used for reflecting, while polarization rotating as a third polarized light. The second polarization beam splitting film receives and reflects the third polarized light as a second polarization reflected light in the first polarization state. The second reflective quarter wave composite plate is used for respectively reflecting, while polarization rotating, the first polarization reflected light and the second polarization reflected light as a first output light and a second output light in the second polarization state in opposition to the second direction. The utilization ratio of the illumination lights could be increased.

### CROSS-REFERENCE TO RELATED APPLICATIONS

This application claims priority to American Provisional Patent Application No. 61/145,698, filed on Jan. 19, 2009, entitled “Polarizer Assembly”, which is hereby incorporated by reference in its entirety.

### FIELD OF THE TECHNOLOGY

The present application relates to microdisplay projection systems, and more particularly to a polarizer assembly and a reflective modulation-imager projection system, which is a microdisplay projection system employing reflective polarization microdisplay imagers and polarizing beam splitter.

### BACKGROUND

Microdisplay projection systems typically employ a transmissive or a reflective microdisplay imager, commonly referred to as a light valve or light valve array, which imposes an image on an illumination light beam. One of the important advantages on reflective light valves over transmissive light valves is that reflective light valves permit controlling circuitry to be placed in situ behind the reflective surface, and more advanced integrated circuit technology is available because the substrate materials are not limited by their opaqueness.

Liquid-crystal-on-silicon (LCOS) imagers rotate while modulate and reflects the polarization of incident light. Thus, polarized light is either reflected by the LCOS imager with its polarization state substantially unmodified, or with a degree of polarization rotation imparted to provide a desired grey scale. Accordingly, a polarized light beam is generally used as the input beam for reflective LCOS imagers, while a polarizing beam-splitter (PBS) is typically employed for splitting the incoming light beam to two polarized light beams in orthogonal polarization states.

Widely used for various portable and handheld projection display applications, a typical single reflective modulation panel optical engine employs a single LCOS imager and one polarization beam splitter in the simplest but most compact configuration. One of the most obvious drawbacks of such a microdisplay projection engine, consisting of the single polarization beam splitter and the single LCOS imager, is that only limited portion of illumination light in one polarization state is used for illuminating the LCOS imager and therefore, after modulation and reflection by the imager, total illumination projected through a projection lens onto a projection screen is very limited.

### SUMMARY

The embodiments of the present application provide a polarizer assembly and a reflective modulation-imager projection system, which could increase the utility ratio of the lights in the projection system, thereby increasing projection brightness.

The embodiments of the present application provide a polarizer assembly, which comprises a light source, a polarization beam splitter assembly, a first reflective quarter wave composite plate and a second reflective quarter wave composite plate.

The light source is used for inducing illumination light in a first direction, wherein the illumination light consists of first polarized light in first polarization state and second polarized light in second polarization state perpendicular to the first polarization state.

The polarization beam splitter assembly comprises a first polarization beam splitting film and a second polarization beam splitting film.

The first polarization beam splitting film is used for first receiving the illumination light at a first incident angle α and reflecting the first polarized light as a first polarization reflected light in a second direction while transmitting the second polarized light.

The second polarization beam splitting film is used for, at a second incident angle β, receiving and transmitting the second polarized light passing through the first polarization beam splitting film.

The first reflective quarter wave composite plate is used for reflecting, while polarization rotating as a third polarized light in the first polarization state in opposition to the first direction, the second polarized light passing through the first polarization beam splitting film and the second polarization beam splitting film, wherein the second polarization beam splitting film receives and reflects the third polarized light as a second polarization reflected light in the first polarization state in the second direction.

The second reflective quarter wave composite plate is used for respectively reflecting, while polarization rotating, the first polarization reflected light and the second polarization reflected light as a first output light and a second output light in the second polarization state.

The above polarizer assembly could further comprises an output homogenizer, which is used for receiving, homogenizing and transmitting the first output light and the second output light in opposition to the second direction.

The embodiments of the present application also provide a reflective modulation-imager projection system, which comprises the polarization assembly provided by the embodiments of the present application, and a projection lens system. The polarization assembly outputs the first output light and the second output light to the projection lens system.

Through the above technical solutions, the two lights with different polarization states in the illumination light are transmitted, reflected and polarized through different light paths to be changed as lights with the single polarization state for projecting. Since almost all illumination lights could be utilized completely, the utilization ratio of the illumination lights is increased, and the brightness of the projection system could be increased. In addition, the above technical solutions is suitable for reflective microdisplay imager, so the advantages of the reflective microdisplay could not be restrained.

### BRIEF DESCRIPTION OF THE DRAWINGS

The disclosure may be more completely understood in consideration of the following detailed description of various embodiments in connection with the accompanying drawings, in which:

FIG. 1 is a structural schematic view of the polarizer assembly according to Embodiment one of the present application;

FIG. 2 is a cross section view of the polarizer assembly according to Embodiment two of the present application;

FIG. 3 is a cross section view of the polarizer assembly according to Embodiment three of the present application which is applied in a reflective modulation imager projection system;

FIG. 4 is a partial cross section view of a reflective modulation imager projection system according to Embodiment four of the present application; and

FIG. 5 is a partial cross section view of a reflective modulation imager projection system according to Embodiment five of the present application.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the present disclosure.

### DETAILED DESCRIPTION

In order to make the objects, technical solutions and merits of the present invention clearer, a further detailed description of embodiments of the present invention is given by reference to accompanying drawings.

The present disclosure is considered to be widely applicable to various microdisplay projection systems. In particular, the polarizer assembly provided by the present application is related to optical projection engines employing one second reflective quarter wave composite plate, a pair of polarization beam splitting films and a first reflective quarter wave composite plate which jointly provides improved optical performance in projection. While the present application is not so limited, an appreciation of various aspects of the present application will be gained through a discussion of the embodiments provided below.

The first polarization beam splitting film reflects the illumination light in the first polarization state to the second reflective quarter wave composite plate, while the second polarization beam splitting film and the first reflective quarter wave composite plate in conjunction convert the illumination light in second polarization state passing through the first polarization beam splitting film to the first polarization state and reflects the converted light to the second reflective quarter wave composite plate. Combined illumination lights is polarization rotated from the first polarization state to the second polarization state, and reflected by the second reflective quarter wave composite plate back to and through the polarization beam splitter assembly.

In one of the most useful extended embodiments of the present application, such a polarizer assembly is employed as a polarized illumination light source to a microdisplay projection system incorporating a reflective polarization modulation imager such as LCOS. Another extended embodiment incorporates a micro electrical-mechanical interferometric pixel array device, such as a Galvanic light valve (GLV) array device, with a third quarter wave plate as an equivalent LCOS imager.

### Embodiment One

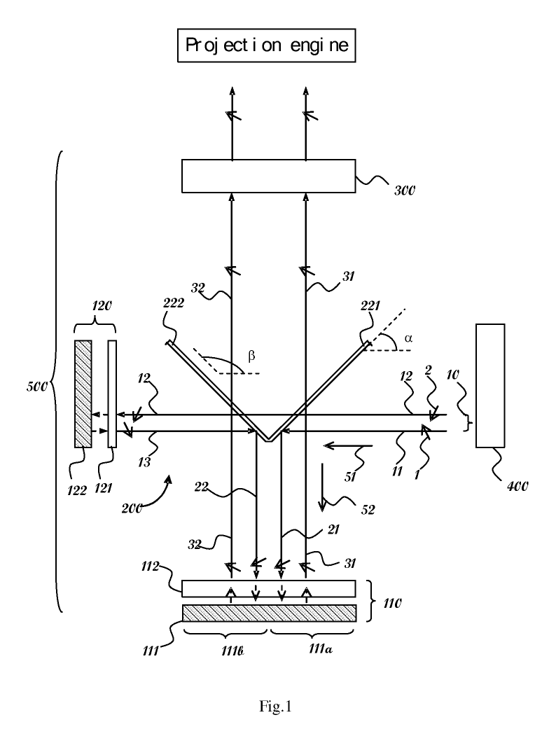

FIG. 1 is a structural schematic view of the polarizer assembly according to embodiment one of the present application. The polarizer assembly 500 comprises a light source 400, a first reflective quarter wave composite plate 120, a second reflective quarter wave composite plate 110 and a polarization beam splitter assembly 200. The polarization beam splitter assembly 200 concretely comprises a first polarization beam splitting film 221 and a second polarization beam splitting film 222 in a V-notch pairing configuration.

As illustrated in FIG. 1, the light source 400 emits illumination light 10 comprising a first polarized light 11 in a first polarization state 1 and a second polarized light 12 in a second polarization state 2 orthogonal to the first polarization state 1, towards the polarization beam splitter assembly 200 along a first direction 51. The twp parts of lights with different polarization states in the illumination light 10 pass through different light paths.

Set at a first incident angle α with the first direction 51, that is, receiving the induced illumination light 10 with the first incident angle α, a first polarization beam splitting film 221 in the polarization beam splitter assembly 200 is arranged for substantially reflecting the first polarized light 11 in the first polarization state 1 as a first polarization reflected light 21 in a second direction 52. The first polarization beam splitting film 221 is arranged for substantially transmitting the second polarized light 12 in the second polarization state 2, so as to make the second polarized light 12 be transmitted in the first direction 51. The first polarization beam splitting film 221 is configured at the first incident angle α with the first direction 51 for effecting a ration between reflection of the first polarized light 11 and transmission of the second polarized light 12 by first polarization beam splitting film 221. The first incident angle α could be adjusted to obtain a maximum ratio close to one between reflection and transmission. Preferably, the first incident angle α is equal to or closed to 45 degree.

The second reflective quarter wave composite plate 110 is used for reflecting, while polarization rotating, the first polarization reflected light 21 as the first output light 31 in the second polarization state 2 transmitted in opposition to the second direction 52.

Specifically, the second reflective quarter wave composite plate 110 includes the first half facing area 111a and the second half facing area 111b. The first half facing area 111a aligned with the first polarization beam splitting film 221, for: a) receiving the first polarization reflected light 21 reflected by the first polarization beam splitting film 221 in the second direction 52; b) polarization rotating the first polarization reflected light 21 from the first polarization state 1 to the second polarization state 2; c) reflecting thus polarization rotated light, as a first output light 31 in the second polarization state 2 transmitted in opposition to the second direction 52, back to the polarization beam splitter assembly 200. Subsequently the first polarization beam splitting film 221 of the polarization beam splitter assembly 200 transmits the first output light 31 in the second polarization state 2 in opposition to the second direction 52. In order to meet the above light paths, as shown in FIG. 1, the first half facing area 111a is perpendicular to the second direction 52.

The path described above is a light path of the first polarized light 11 of the illumination light 10. Passing through the above optical components, the first polarized light 11 could be converted as the first output light 31 transmitted in opposition to the second direction 52, and subsequently used for projecting.

The second polarized light 12, after transmitting through the first polarization beam splitting film 221, is transmitted continuously in the first direction 51. The optical components in the subsequent light path of the second polarized light 12 are as follows.

The second polarization beam splitting film 222 has the second incident angle β with the first direction 51. The second incident angle β is preferably equal to or close to the first incident angleα+90 degree. The second polarization beam splitting film 222, at the second incident angle β, receives and transmits the second polarized light 12 passing through the first polarization beam splitting film 221.

The first reflective quarter wave composite plate 120 is arranged opposite to the light source 400, and towards the second polarization beam splitting film 222. The first reflective quarter wave composite plate 120 is used for reflecting, while polarization rotating, the second polarized light 12 passing through the first polarization beam splitting film 221 and the second polarization beam splitting film 222, as a three polarized light 13 in the first polarization state 1 and transmitted in opposition to the first direction 51. The first reflective quarter wave composite plate 120 is arranged for: a) receiving major portion of the second polarized light 12 in the second polarization state 2 transmitted first through the first polarization beam splitting film 221 and secondly through the second polarization beam splitting film 222 in the first direction 51; b) polarization rotating the received second polarized light 12 from the second polarization state 2 to the first polarization state 1; and c) reflecting thus polarization rotated light, as a third polarized light 13 in the first polarization state 1, back to the polarization beam splitter assembly 200, particularly to the second polarization beam splitting film 222, in opposition to the first direction 51.

Then, the second polarization beams splitting film 222, in a second incident angle β with the first direction 51, reflects the received third polarized light 13 in the first polarization state 1 as a second polarization reflected light 22 in the first polarization state 1 transmitted in the second direction 52. The second polarization reflected light 22 is in parallel to the first polarization reflected light 21 transmitted towards the second reflective quarter wave composite plate 110, and particularly onto the second half facing area 111b of the second reflective quarter wave composite plate 110.

The second half facing area 111b is aligned with the second polarization beam splitting film 222, similar to the first half facing area 111a, and used for reflecting the second polarization reflected light 22, while polarization rotating, as a second output 32 in the second polarization state 2 transmitted in opposition to the second direction 52. Particularly, the second half facing area 111b of the second reflective quarter wave composite plate 110 is configured for: a) receiving the second polarization reflected light 22 in the second direction 52; b) polarization rotating major portion of the second polarization reflected light 22 from the first polarization state 1 to the second polarization state 2; c) reflecting thus polarization rotated light, as the second output light 32 in the second polarization state 2, back to the polarization beam splitter assembly 200 in opposition to the second direction 52, and in particular, the second polarization beam splitting film 222.

Subsequently, the polarization beam splitter assembly 200 transmits the second output light 32, along with the first output light 31, in the second polarization state 2 in opposition to the second direction 52.

The second polarized light 12 of the illumination light 10 is converted to be the second output light 32 in the second polarization state 2 by passing through the above light path, and the second output light 32 has the same direction and polarization state as the first output light 31, which could be used for projecting along with the first output light 31.

By using the technical solution of the present application, almost all the illumination light 10 could be used as projecting light, thereby increasing the utilization ratio of the illumination light in the projection system and enhancing the projecting brightness. In addition, the power used for driving the light source 400 could be decreased to accomplish the same brightness under the same condition.

In the present embodiment, the first direction 51 and the second direction 52 is perpendicular each other. The polarization beam splitter 200 is disposed between the light source 400 and the first reflective quarter wave composite plate 120, and the second reflective quarter wave composite plate 110 is disposed on one side of the polarization beam splitter 200. In specific application, the position of all optical components is not limited to the relationship shown in FIG. 1, as long as it could accomplish the above light paths of the first polarized light 11 and the second polarized light 12.

The polarizer assembly 500 may further include a output homogenizer 300, which is used for receiving, homogenizing and transmitting the first output light 31 and the second output light 32 in opposition to the second direction 52. The polarization beam splitter 200 particularly transmits the first output light 31 and the second output light 32 towards the output homogenizer 300.

In the present embodiment, the first reflective quarter wave composite plate 120 is preferably composed of a first transmissive quarter wave plate 121 and a first planar mirror 122 in parallel from front to back position facing the polarization beam splitter assembly 200, that is, the first transmissive quarter wave plate 121 is disposed between the polarization beam splitter assembly 200 and the first planar mirror 122 and is preferably perpendicular to the first direction 51. Those two component plates are selectively adhered into a stacking composite configuration. Meanwhile, the second reflective quarter wave composite plate 110 is also preferably composed of a first transmissive quarter wave plate 111 and a second planar mirror 112 in parallel from front to back positions facing the polarization beam splitter assembly 200, that is, the second transmissive quarter wave plate 112 is disposed between the polarization beam splitter assembly 200 and the second planar mirror 112 and is preferably perpendicular to the second direction 52. Those two component plates are selectively adhered into a stacking composite configuration.

Typically, the first polarization beam splitting film 221 and the second polarization beam splitting film 222 are either a multilayer polarizing beam splitting film or a wire grid polarizing plate, both providing the best reflection to transmission ratio at an incident angle close to 45-degree. Thus, the first incident angle α and the second incident angle β are preferably set equal or close to 45-degree and 135-degree (45+90 degree) respectively.

Through polarized illumination light components in both orthogonal stats are utilized at improved percentage in this configuration, there would be certain difference in brightness or intensity between the illumination light 10 received by the first half facing area 111a and the second half facing area 111b. Particularly the second portion of illumination light 10 in the second polarization state 2 would go through longer pass and optical components than the first portion in the first polarization state 1, before reaching the second reflective quarter wave composite plate 110, that is, the second polarization reflected light 22 passes through longer light path and more optical components than the first polarization reflected light 21. Thus, in the specific application, the polarizer assembly 500 also provided with a adjusting-balancing means. The adjusting-balancing means is used for adjusting and balancing the overall brightness between the first output light 31 from the first half facing area 111a and the second output light 32 from the second half facing area 111b of the second reflective quarter wave composite plate 110. There are many embodiments to accomplish the adjusting-balancing means. Such means include, but not limited to: 1) to add optical compensation, particularly light deduction on the first half facing area 111a, that is, a light decaying means could be applied as the adjusting-balancing means, disposed onto the second reflective quarter wave composite plate 110, and used for decaying the brightness of the first output light 31; 2) to purposely reduce the intensity of the first portion of illumination light 10 in the first polarization state 1 before inducing it to the polarization beam splitter assembly 200, that is, the light decaying means could be applied as the adjusting-balancing means, disposed between the light source 400 and the polarization beam splitter assembly 200 and used for decaying the brightness of the first polarized light 11; or 3) to lower the first incident angle α below 45-degree and the second incident angle β less than 135-degree (α+90-degree) for expanding the projected area of the first half facing area 111a or reducing the projected area of the second half facing area 111b simultaneously, or both expanding the projected area of the first half facing area 111a and reducing the projected area of the second half facing area 111b, and thus balancing the illumination light 10 onto the two facing areas 111a and 111b of the second reflective quarter wave composite plate 110.

### Embodiment Two

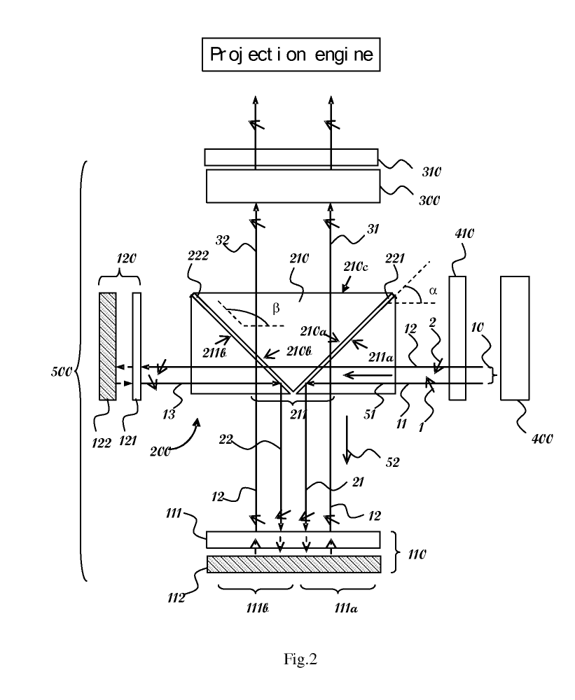

FIG. 2 is a cross section view of the polarizer assembly according to embodiment two of the present application. In the present embodiment, the polarizer assembly 500 also includes a projection polarization plate 310. The projection polarization plate 310 is employed and configured beyond the output homogenizer 300 and opposite to the polarization beam splitter assembly 200. The projection polarization plate 310 is used for receiving and transmitting the first output light 31 and the second output light 32 in the second polarization state 2 passing through the output homogenizer 300, helps absorbing or back reflecting light in the first polarization state 1.

Besides, as shown in FIG. 2, the polarization beam splitter 200 may further includes a first 3-sided prism 210. The first 3-sided prism 210 comprises a first side face 210a, a second side face 210b and a third face 210c while the third face 210c faces to the output homogenizer 300. The first polarization beam splitting film 221 and the second polarization beam splitting film 222 could be adequately configured at their preferred incident angles as attached onto a first side face 210a and a second side face 210a of a first 3-sided prism 210, respectively. In particular, a continuous multilayer polarization beam splitting film could be deposited onto the two faces of such a first 3-sides prism 210 forming a 90-degree right angle, the first side face 210a and the second side face 210b, while the third side face 210c of the first 3-sided prism 210 faces the output homogenizer 300.

The polarization beam splitter 200 may further includes a first prism assembly 211. the first prism assembly 211 includes a first V-notch side face 211a and a second V-notch side face 211b in a concave configuration. Similarly, the first polarization beam splitting film 221 and the second polarization beam splitting film 222 could also be adequately configured at their preferred incident angles as attached onto a first V-notch side face 211a and a second V-notch side face 211b of a first prism assembly 211 in a concave configuration.

In the present embodiment, the first polarization beam splitting film 221 and the second polarization beam splitting film 222 are sandwiched between the first 3-sided prism 210 and the first prism assembly 211. The first polarization beam splitting film 221 is sandwiched between the first side face 210a and first V-notch side face 211a, and the second polarization beam splitting film 222 is sandwiched between the second side face 210b and the second V-notch side face 211b, so as to form the polarization beam splitter assembly 200 in a more integrated configuration. In such a configuration, even the second reflective quarter wave composite plate 110 and/or the first reflective quarter wave composite plate 120 could be adherently attached onto the polarization beam splitter assembly 200, that is, the first reflective quarter wave composite plate 120 may be adherently attached to the first prism assembly 211 of the polarization beam splitter assembly 200. The second reflective quarter wave composite plate 110 also may be adherently attached to the first prism assembly 211 of the polarization beam splitter assembly 200.

The first 3-sided prism 210 and the first prism assembly 211 could be used by combined each other as FIG. 2, or they could be used independently in the polarization beam splitter assembly 200.

As shown in FIGS. 1 and 2, the light source 400 in the polarizer assembly 500 as disclosed and exemplified above can be any suitable light source including but not limited to conventional light sources such as, for example, arc lamps, tungsten lamps, halide lamps and the alike, and alternatives such as electromagnetic ballast, light emitting diodes and lasers. Also, a light conditioner 410 could be placed between the light source 400 and the first polarization beam splitting film 221 of the polarization beam splitter assembly 200, for conditioning light emitted from the light source 400 as the combined, collimated illumination light 10 towards the polarization beam splitter assembly 200 with improved collimation and brightness uniformity among others.

The embodiments of the present application also provide a reflective modulation-imager projection system, which is a microdisplay projection system, The system includes the polarizer assembly provided by any one embodiment of the present application, and further includes a projection lens system. The polarizer assembly could output the first output light and the second output light in the second polarization state to the projection lens system so as to project image.

### Embodiment Three

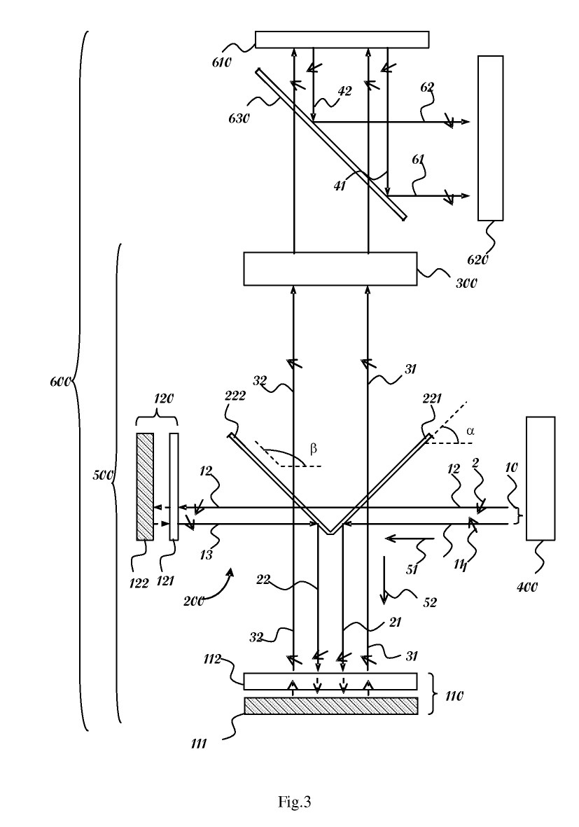

FIG. 3 is a cross section view of the polarizer assembly according to Embodiment three of the present application which is applied in a reflective modulation imager projection system. In the present embodiment, the reflective modulation-imager projection system 600 includes the polarizer assembly 500 and the projection lens system 620, and further includes at least one reflective polarization modulation imager 610 and a third polarization beam splitting film 630.

Through the polarizer assembly 500, polarized illumination light consisting of the first output light 31 and the second output light 32 both in the second polarization state 2 is induced to a third polarization beam splitting film 630. In the present embodiment, the third polarization beam splitter film 630 is configured to transmit, in majority portion, the received first output light 31 and the second output light 32 both in the second polarization state 2 to a reflective polarization modulation imager 610. The reflective polarization modulation imager 610 facing the third polarization beam splitter 630 opposite to the polarizer assembly 500, receives, polarization modulates and reflects the first output light 31 and the second output light 32, as a first polarization modulated light 41 and a second polarization modulated light 42 both in the first polarization state 1 which are therefore reflected by the third polarization beam splitter film 630, as a first projection light 61 and a second projection light 62 both in the first polarization state 1 towards a projection lens system 620.

In the present embodiment, there are one reflective polarization modulation imager 610 and one third polarization beam splitting film 630, the reflective polarization modulation imager 610 is perpendicular to the second direction 52, and the third polarization beam splitting film 630 is disposed between the reflective polarization modulation imager 610 and the polarizer assembly 500. The third polarization beam splitting film 630 is set at 45-degree with the second direction 52. The projection lens system 620 is disposed towards the reflecting face of the third polarization beam splitting film 630 and is parallel to the first direction 51.

The position relationship of the reflective polarization modulation imager 610, the third polarization beam splitting film 630 and the projection lens system 620 is not limited to the above description. The amount of the reflective polarization modulation imager 610 and the third polarization beam splitting film 630 is not limited to be one as shown in FIG. 3, as long as the first output light 31 and the second output light 32 could be polarization rotating to be in the first polarization state 1 and transmitted to the projection lens system 620.

Though most of the components consisting of both the polarizer assembly 500 and the rest of the reflective modulation imager projection system 600 are placed perpendicular to the drawing plane on the paper in FIG. 3 for illustrating the principle, extended configurations are obviously valid in which the polarizer assembly 500 is rotated around the axis of the second direction 52, for example, by 90, 180 and 270 degrees out of the drawing plane on the paper.

### Embodiment Four

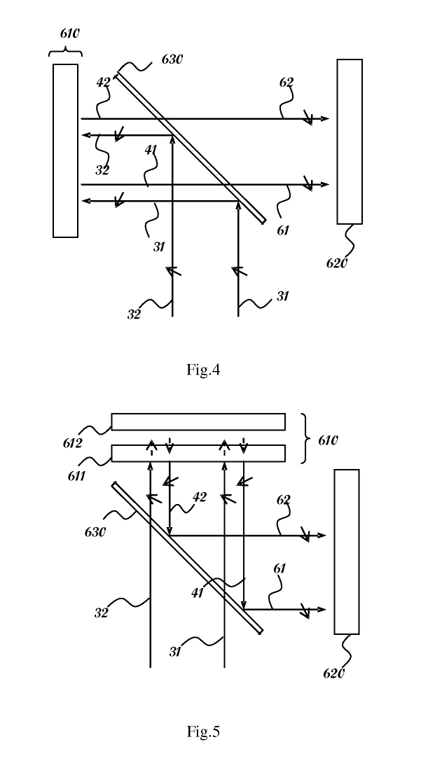

FIG. 4 is a cross section view of the reflective modulation imager projection system according to Embodiment four of the present application. The reflective modulation-imager projection system could apply the polarizer assembly 500 provided by any one embodiment of the present application, and further include at least one reflective polarization modulation imager 610 and third polarization beam splitting film 630. The third polarization beam splitting film 630 reflects the first output light 31 and the second output light 32 both in the second polarization state 2 to the reflective polarization modulation imager 610; and the reflective polarization modulation imager 610 reflects and rotates to polarize the first output light 31 and the second output light 32 as a first polarized modulated light 41 and a second polarized modulated light 42 both in the first polarization state 1. Compared with the embodiment three, the difference of the present embodiment lies in that the first polarized modulated light 41 and the second polarized modulated light 42 are transmitted by the third polarization beam splitting film 630 towards the projection lens system 610. FIG. 4 shows one manner of the position relationship of the reflective polarization modulation imager 610, the third polarization beam splitting film 630 and the projection lens system 620, which could accomplish the above light path.

Alternatively, the third polarization beam splitter 630 is configured for reflecting the received first output light 31 and the received second output light 32 both in the second polarization state 2 towards the reflective polarization modulation imager 610. Accordingly, the reflective polarization modulation imager 610 polarization modulates the received first output light 21 and the second output light 32 as the first polarization modulated light 41 and the second polarization modulated light 42 both in the first polarization state 1, and reflects them to the third polarization beam splitter 630. The first polarized modulated light 41 and the second polarized modulated light 42 are transmitted by the third polarization beam splitting film 630 as the first projection light 61 and the second projection 62, and thus reaching the projection lens system 620.

In the present embodiment, the third polarization beam splitting film 630 is disposed towards the polarizer assembly 500, and is set at 45-degress with the second direction 2. The reflective polarization modulation imager 610 and the projection lens system 620 are perpendicular to the second direction 52. The third polarization beam splitting film 630 is disposed between the reflective polarization modulation imager 610 and the projection lens system 620. The reflecting face of the third polarization beam splitting film 630 is towards the reflective polarization modulation imager 610.

In the embodiments of the present application, a liquid crystal on silicon microdisplay imager may be employed as the reflective polarization modulation imager 610, providing the needed spatial light modulation and reflection along with 90-degree polarization rotation.

By using the above technical solution, the direction and the polarization state of the first output light and the second output light could be converted flexibly, so the position of the projection lens system and the direction of the output light could not be limited.

### Embodiment Five

FIG. 5 is a partial cross section view of a reflective modulation imager projection system according to Embodiment five of the present application. The reflective modulation-imager projection system could apply the polarizer assembly 500 provided by any one embodiment of the present application. In the present embodiment, the reflective polarization modulation imager 610 comprises a third quarter wave plate 611 and a reflective intensity-modulation imager 612 overlapped and parallel each other, and the third quarter wave plate 611 is disposed between the third polarization beam splitting film 630 and the reflective intensity-modulation imager 612.

In particular, a reflective intensity modulation imager 612 may simply comprise a planar array of micro electrical-mechanical pixels modulating intensity of incident illumination through interferometry, that is, consist of an array of micro electrical-mechanical interferometric pixels in a regularly tiled planar arrangement in one of the extended embodiments, such as a GLV array device.

Finally, it should be noted that the above embodiments are merely provided for describing the technical solutions of the present invention, but not intended to limit the present invention. It should be understood by those of ordinary skill in the art that although the present invention has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the present invention.

What is claimed is:

1. A polarizer assembly, comprising:
a light source, for inducing illumination light in a first direction, wherein the illumination light consists of first polarized light in first polarization state and second polarized light in second polarization state perpendicular to the first polarization state;
a polarization beam splitter assembly comprising:
a first polarization beam splitting film, for first receiving the illumination light at a first incident angle α and reflecting the first polarized light as a first polarization reflected light in a second direction while transmitting the second polarized light, and
a second polarization beam splitting film, for, at a second incident angle β, receiving and transmitting the second polarized light passing through the first polarization beam splitting film; and
a first reflective quarter wave composite plate, for reflecting, while polarization rotating as a third polarized light in the first polarization state in opposition to the first direction, the second polarized light passing through the first polarization beam splitting film and the second polarization beam splitting film, wherein the second polarization beam splitting film receives and reflects the third polarized light as a second polarization reflected light in the first polarization state in the second direction;
a second reflective quarter wave composite plate, for respectively reflecting, while polarization rotating, the first polarization reflected light and the second polarization reflected light as a first output light and a second output light in the second polarization state.

2. The polarizer assembly according to claim 1, wherein the first direction is perpendicular to the second direction.

3. The polarizer assembly according to claim 1, wherein the first polarization beam splitting film and the second polarization beam splitting film are either a multilayer polarizing beam splitting film or a wire grid polarizing plate.

4. The polarizer assembly according to claim 1, wherein the first reflective quarter wave composite plate comprises a first transmissive quarter wave plate and a first planar mirror parallel each other, the first transmissive quarter wave plate is disposed between the polarization beam splitter assembly and the first planar mirror and is perpendicular to the first direction.

5. The polarizer assembly according to claim 1, wherein the second reflective quarter wave composite plate comprises a second transmissive quarter wave plate and a second planar mirror parallel each other, the second transmissive quarter wave plate is disposed between the polarization beam splitter assembly and the second planar mirror and is perpendicular to the second direction.

6. The polarizer assembly according to claim 1 further comprising an output homogenizer, for receiving, homogenizing and transmitting the first output light and the second output light in opposition to the second direction.

7. The polarizer assembly according to claim 6 further comprising a projection polarization plate, placed beyond the output homogenizer and in opposition to the polarization beam splitter assembly, for receiving and transmitting the first output light and the second output light passing through the output homogenizer while absorbing or back reflecting light in the first polarization state.

8. The polarizer assembly according to claim 1, wherein the polarization beam splitter assembly further comprises a first 3-sided prism comprising a first side face, a second side face and a third face while the third face faces to the output homogenizer, wherein the first polarization beam splitting film and the second polarization beam splitting film are adherently attached to the first side face and the second side face.

9. The polarizer assembly according to claim 1, wherein the polarization beam splitter assembly further comprises a first prism assembly comprising a first V-notch side face and a second V-notch side face in a concave configuration, wherein the first polarization beam splitting film and the second polarization beam splitting film are adherently attached to the first V-notch side face and the second V-notch side face, respectively.

10. The polarizer assembly according to claim 9, wherein the polarization beam splitter assembly further comprises a first 3-sided prism comprising a first side face, a second side face and a third face while the third face faces to the output homogenizer; the first polarization beam splitting film is sandwiched between the first side face and the first V-notch side face; and the second polarization beam splitting film is sandwiched between the second side face and the second V-notch side face.

11. The polarizer assembly according to claim 8, wherein the second reflective quarter wave composite plate and/or the first reflective quarter wave composite plate is adherently attached to the first prism assembly of the polarization beam splitter assembly.

12. The polarizer assembly according to claim 9, wherein the second reflective quarter wave composite plate and/or the first reflective quarter wave composite plate is adherently attached to the first prism assembly of the polarization beam splitter assembly.

13. The polarizer assembly according to claim 1, wherein the light source is provided with any one or combination of arc lamps, tungsten lamps, halide lamps, electromagnetic ballast, light emitting diodes and lasers.

14. The polarizer assembly according to claim 1 further comprising a adjusting-balancing means, for adjusting and balancing brightness of the first output light and the second output light from the second reflective quarter wave composite plate.

15. The polarizer assembly according to claim 1, wherein the first incident angle α is less than 45-degree and the second incident angle β is less than α+90-degree.

16. The polarizer assembly according to claim 14, wherein the first incident angle α is less than 45-degree and the second incident angle β is less than α+90-degree.

17. The polarizer assembly according to claim 14, wherein the adjusting-balancing means is a light decaying means, which is disposed on the second reflective quarter wave composite plate, for decaying the brightness of the first output light, or which is disposed between the light source and the polarization beam splitter assembly, for decaying the brightness of the first polarized light.

18. A reflective modulation-imager projection system comprising the polarization assembly according to claim 1 and a projection lens system, wherein the polarization assembly outputs the first output light and the second output light to the projection lens system.

19. The system according to claim 18, wherein
further comprises at least one reflective polarization modulation imager and a third polarization beam splitting film;
the third polarization beam splitting film transmits and thus induces the first output light and the second output light both in the second polarization state to the reflective polarization modulation imager; and
the reflective polarization modulation imager reflects and rotates to polarize the first output light and the second output light as a first polarized modulated light and a second polarized modulated light both in the first polarization state, and the first polarized modulated light and the second polarized modulated light are reflected by the third polarization beam splitting film to be a first projected light and a second projected light transmitting towards the projection lens system.

20. The reflective modulation-imager projection system according to claim 18, wherein further comprises at least one reflective polarization modulation imager and a third polarization beam splitting film;
the third polarization beam splitting film reflects the first output light and the second output light both in the second polarization state to the reflective polarization modulation imager; and
the reflective polarization modulation imager reflects and rotates to polarize the first output light and the second output light as a first polarized modulated light and a second polarized modulated light both in the first polarization state, and the first polarized modulated light and the second polarized modulated light are transmitted by the third polarization beam splitting film to be a first projected light and a second projected light transmitting towards the projection lens system.

21. The reflective modulation-imager projection system according to claim 19, wherein the reflective polarization modulation imager is a liquid crystal on silicon microdisplay imager.

22. The reflective modulation-imager projection system according to claim 20, wherein the reflective polarization modulation imager is a liquid crystal on silicon microdisplay imager.

23. The reflective modulation-imager projection system according to claim 19, wherein the reflective polarization modulation imager consists of a third quarter wave plate and a reflective intensity-modulation imager parallel each other, and the third quarter wave plate is disposed between the third polarization beam splitting film and the reflective intensity-modulation imager.

24. The reflective modulation-imager projection system according to claim 20, wherein the reflective polarization modulation imager consists of a third quarter wave plate and a reflective intensity-modulation imager parallel each other, and the third quarter wave plate is disposed between the third polarization beam splitting film and the reflective intensity-modulation imager.
